(19) United States
(12) Patent Application Publication
(10) Pub. No.: US 2010/0177139 A1
(43) Pub. Date: Jul. 15, 2010

(54) INKJET IMAGE FORMING APPARATUS

(75) Inventor: Gu-hwan NA, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/554,037

(22) Filed: Sep. 4, 2009

(30) Foreign Application Priority Data
Jan. 13, 2009 (KR) 10-2009-0002723

(51) Int. Cl. B41J 29/393; B41J 2/125

(52) U.S. Cl. 347/19; 347/12

(57) ABSTRACT

An inkjet image forming apparatus including an array inkjet head including at least one head chip row, the at least one head chip having a plurality of head chips on which nozzles are formed; a light emitting unit including a light emitting device that is disposed on a first side of the head chip rows in a main scanning direction and radiates light; a light receiving unit including a light receiving device that is disposed on a second side of the head chip rows in the main scanning direction and faces the light emitting device to detect the light; and a malfunctioning nozzle detection unit that controls the array inkjet head to eject ink across the light and detects malfunctioning nozzles using detection signals received from the light receiving unit, wherein an alignment error angle between the light emitting unit and the light receiving unit is Arctan[(D−C)/A] or less when a length of the head chip rows in the main scanning direction is A, a gap between nozzles furthest from each other in a sub-scanning direction in one of the head chips is C, and a width of the light receiving unit is D.

### CROSS-REFERENCE TO RELATED APPLICATIONS

This application claims the benefit of Korean Patent Application No. 10-2009-0002723, filed on Jan. 13, 2009, in the Korean Intellectual Property Office, the disclosure of which is incorporated herein in its entirety by reference.

### BACKGROUND

1. Field of the Invention

The present general inventive concept relates to an inkjet image forming apparatus that includes an inkjet head having a nozzle unit that has a length in a main scanning direction greater than a minimum width of a printing medium.

2. Description of the Related Art

In general, an inkjet image forming apparatus is a device that can print an image via a shuttle type inkjet head that reciprocally travels in a main scanning direction and ejects ink droplets onto a printing medium that travels in a sub-scanning direction perpendicular to the main-scanning direction. The inkjet head includes a nozzle unit having a plurality of nozzles that eject ink. Ink droplets that are not ejected remain on the nozzle unit. While a printing operation is not performed and the nozzle unit is exposed to air, the ink droplets on the nozzle unit may solidify and foreign materials such as fine dusts may adhere to the nozzle unit. The solidified ink droplets and the adhered foreign materials distort the direction of ink ejection, and as a result, the printing quality is reduced. Also, nozzles of the nozzle unit may be blocked by ink dried on the nozzles. In order to prevent the nozzles of the nozzle unit from being blocked, it is necessary to perform a maintenance operation that removes foreign materials from the nozzle unit.

Recently, attempts have been made to realize high speed printing using an array inkjet head, instead of a shuttle type inkjet head, having a nozzle unit that has a length in the main scanning direction greater than a minimum width of a printable printing medium. In an inkjet image forming apparatus that uses the array inkjet head as described above, the inkjet head is fixed and only the printing medium is moved in a cross-scanning direction. Accordingly, a driving device of the inkjet image forming apparatus is simple, and thus high speed printing may be realized. In the inkjet image forming apparatus, in order to correspond to a printing medium, for example, A4, the length of a nozzle unit of the array inkjet head may be approximately 210 mm if printing margins of the printing medium along a width direction are not considered. In an array inkjet head, unlike a shuttle type inkjet head in which a nozzle unit reciprocally moves in a main scanning direction, a nozzle unit of the array inkjet head ejects ink from a fixed position. Thus, when some of the nozzles of the nozzle unit are blocked or an ink ejection direction is distorted due to foreign materials attached to the nozzles, printing quality is reduced.

### SUMMARY

The present general inventive concept provides an inkjet image forming apparatus that can detect malfunctioning nozzles from among a plurality of nozzles of an inkjet array head.

Additional aspects and utilities of the present general inventive concept will be set forth in part in the description which follows and, in part, will be obvious from the description, or may be learned by practice of the general inventive concept.

Exemplary embodiments of the present general inventive concept provide an inkjet image forming apparatus including: an array inkjet head including at least one head chip row, the at least one head chip having a plurality of head chips on which nozzles are formed; a light emitting unit including a light emitting device that is disposed on a first side of the head chip rows in a main scanning direction and radiates light; a light receiving unit including a light receiving device that is disposed on a second side of the head chip rows in the main scanning direction and faces the light emitting device to detect the light; and a malfunctioning nozzle detection unit that controls the array inkjet head to eject ink across the light and detects malfunctioning nozzles using detection signals received from the light receiving unit, wherein an alignment error angle between the light emitting unit and the light receiving unit is Arctan[(D−C)/A] or less when a length of the head chip rows in the main scanning direction is A, a gap between nozzles furthest from each other in a sub-scanning direction in one of the head chips is C, and a width of the light receiving unit is D.

The inkjet image forming apparatus may further include: a frame that forms a structure of the inkjet image forming apparatus; and a supporting member that is coupled to the frame, and to which the light emitting unit and the light receiving unit are coupled.

Exemplary embodiments of the present general inventive concept also provide an inkjet image forming apparatus including: an array inkjet head including at least one head chip row, the at least one head chip row having a plurality of head chips on which nozzles are formed; a light emitting unit including a light emitting device that is disposed on a first side of the head chip rows in a main scanning direction and radiates light; a light receiving unit including a light receiving device that is disposed on a second side of the head chip rows in the main scanning direction and faces the light emitting device to detect the light; and a malfunctioning nozzle detection unit that controls the array inkjet head to eject ink across the light and detects malfunctioning nozzles using detection signals received from the light receiving unit, wherein the light emitting unit and the light receiving unit are coupled to a supporting member, and the supporting member is coupled to a frame on which the array inkjet head is mounted.

The array inkjet head may include a plurality of the head chip rows, the light emitting unit may include a plurality of the light emitting devices corresponding to the plurality of the head chip rows, and the light receiving unit may include a plurality of light receiving devices corresponding to the plurality of the light emitting devices.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A is a schematic side view of an inkjet image forming apparatus according to an embodiment of the present general inventive concept;

FIG. 1B is a schematic perspective view of the inkjet image forming apparatus of FIG. 1A;

FIG. 2 is a plan view of a nozzle unit of the inkjet image forming apparatus of FIG. 1A;

FIG. 3 is a schematic perspective view of a platen and a wiping unit of the inkjet image forming apparatus of FIG. 1A;

FIG. 4 is a cross-sectional view of the wiping unit of FIG. 3;

FIG. 5 is a schematic drawing of a guide slot and a wiping wheel according to exemplary embodiments of the present general inventive concept;

FIG. 6 is a side view of a cap member of the inkjet image forming apparatus of FIG. 1A positioned in a capping position;

FIG. 7 is a block diagram showing a process of optically detecting malfunctioning nozzles employed in the inkjet image forming apparatus of FIG. 1A, according to an embodiment of the present general inventive concept;

FIG. 8A is a plan view showing the dispositions of head chip rows, a light emitting unit, and a light receiving unit;

FIG. 8B is a plan view explaining an aligning error angle of the light emitting unit and the light receiving unit of FIG. 8A;

FIG. 9 is a perspective view of the light emitting unit and the light receiving unit of FIG. 8A; and

FIG.10 is a perspective view showing an operation of first and second shutter by a wiping unit.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

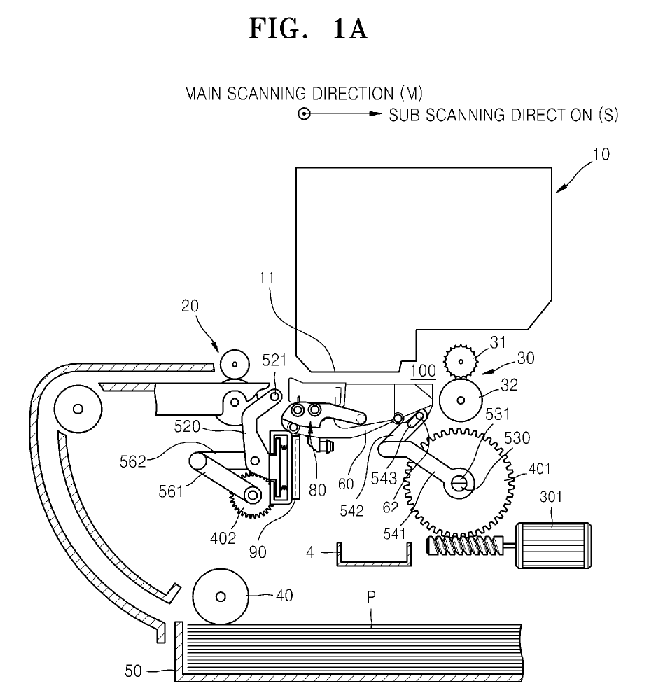

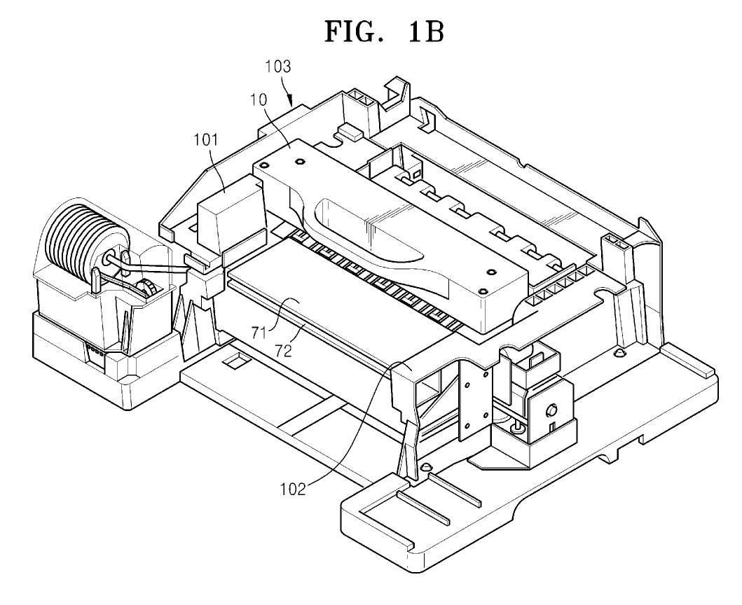

FIGS. 1A and 1B are respectively a schematic side view and a schematic perspective view of an inkjet image forming apparatus according to an embodiment of the present general inventive concept. Referring to FIG. 1A, a printing medium P picked up from a paper supply cassette 50 by a pick-up roller 40 is moved in a sub-scanning direction S by a conveying unit 20. An inkjet head 10 is installed above an area where the printing medium P is positioned to be printed thereon. The inkjet head 10 prints an image onto the printing medium P by ejecting ink onto the printing medium P. The inkjet image forming apparatus includes a frame 103 to form a main body thereof.

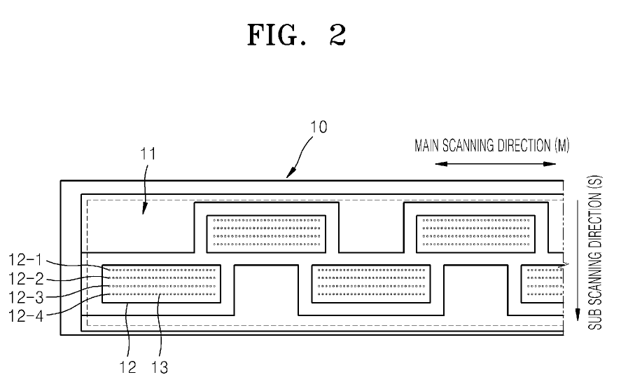

The inkjet head 10 is an array inkjet head that has a nozzle unit 11 having a length along a main scanning direction M corresponding to a width of the printing medium P. FIG. 2 is a plan view of the nozzle unit 11 according to an embodiment of the present general inventive concept. Referring to FIG. 2, the nozzle unit 11 includes a plurality of head chips 12 arranged in a zigzag shape along the main scanning direction M. Each of the head chips 12 includes a plurality of nozzles 13. Each of the head chips 12 may include a plurality of nozzle rows 12-1, 12-2,12-3, and 12-4. The nozzle rows 12-1, 12-2, 12-3, and 12-4 may eject the same color ink. However, the nozzle rows 12-1, 12-2,12-3, and 12-4 may eject different colors of ink (for example, black, cyan, and magenta) from each other to print a color image. FIG. 2 shows an example of the nozzle unit 11, but the nozzle unit 11 according to exemplary embodiments of the present general inventive concept is not limited thereto. Although not shown, the inkjet head 10 may include a chamber connected to the nozzles 13 and flow channels to supply ink to the chamber. The chamber may include an ejection device, for example, a piezoelectric ejection device or a heater, to provide pressure to eject the ink through the nozzles. The chamber, the ejection device, and the flow channels are well known in the art, and thus descriptions thereof will be omitted.

Also, the array inkjet head 10 is not limited to an inkjet head that covers the entire width of a printing medium using a single nozzle unit. For example, although not shown, the array inkjet head 10 may include two or more sub-heads that together cover the entire width of the printing medium by being disposed parallel to each other in the main scanning direction M. The sum of the lengths of two sub-head nozzle units may be such that they cover at least the entire width of the printing medium. The sub-heads may be arranged separately from each other in the sub-scanning direction S.

A platen 60 is disposed to face the nozzle unit 11 to form a paper conveying path 100 by supporting a rear surface of the printing medium P. The platen 60 is positioned such that the nozzle unit 11 of the inkjet head 10 may be maintained at a predetermined distance, for example, approximately 0.5 mm to approximately 2 mm, from the printing medium P. A discharge unit 30 that discharges the printed printing medium P is installed next to an outlet of the inkjet head 10. The discharge unit 30 may include a roller 32 and a star wheel 31 that engage with each other. The roller 32 and the star wheel 31 may be installed on supporting members 71 and 72 (refer to FIG. 1B), respectively. The supporting members 71 and 72 are disposed at an upper and a lower position, respectively, to form a discharge path for the printing medium P. The frame 103 supports the inkjet head 10 and the platen 60 and forms the main body of the inkjet image forming apparatus. The supporting members 71 and 72 are combined to the frame 103 of the inkjet image forming apparatus.

Referring to FIG. 1A, the inkjet image forming apparatus includes a wiping unit 80 and a cap member 90. The wiping unit 80 removes solidified ink and foreign materials on the nozzles 13 by wiping a surface of the nozzle unit 11. The cap member 90 covers the nozzle unit 11, when a printing operation has not been performed for a predetermined period of time, to prevent the nozzle unit 11 from drying by blocking the nozzle unit 11 from contacting air. The platen 60 moves to a printing position to form the paper conveying path 100 and to a maintenance position separated from the nozzle unit 11. The wiping unit 80 is positioned in a first position, where the wiping unit 80 does not block the paper conveying path 100, when the platen 60 is in the printing position. The wiping unit 80 may also be positioned in a second position to detect malfunctioning nozzles 13, which will be described later, and wipes the nozzle unit 11 when reciprocally moving between the first position and the second position. The cap member 90 is positioned such that the cap member 90 does not interrupt the paper conveying path 100 when the platen 60 is in the printing position, and after the platen 60 moves to the maintenance position, the cap member 90 caps the nozzle unit 11. The platen 60, the wiping unit 80, and the cap member 90 may be driven by driving means different from each other. In the current embodiment of the general inventive concept, the wiping unit 80 is connected to the platen 60, and thus moves together with the platen 60.

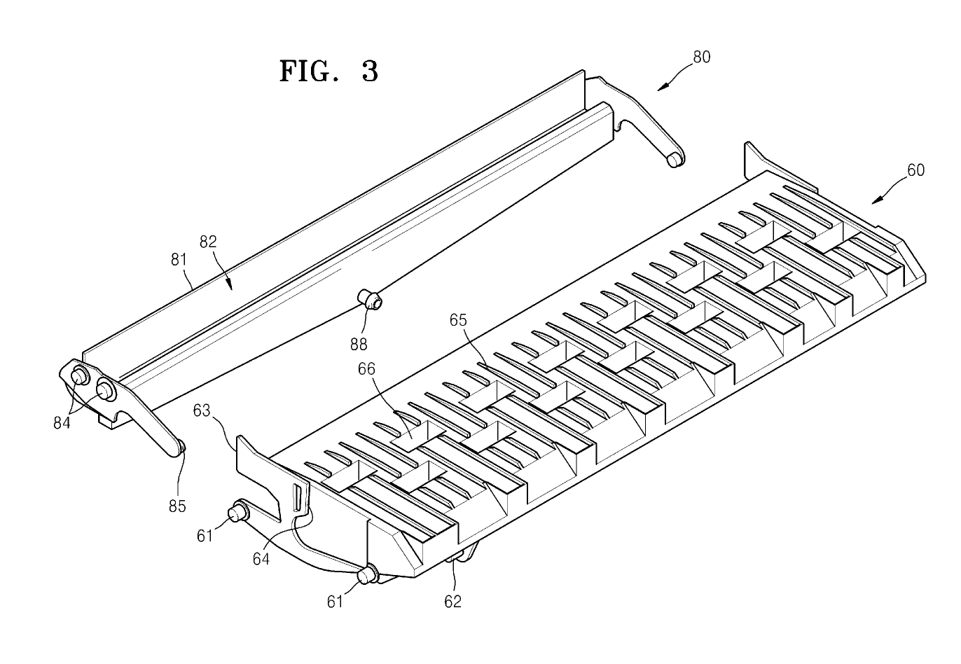

FIG. 3 is an exemplary schematic perspective view of the platen 60 and the wiping unit 80 of FIG. 1A according to the present embodiment. Referring to FIG. 3, a plurality of ribs 65 is provided on an upper surface of the platen 60 to support the rear surface of the printing medium P. Also, in order to accommodate ejected and/or sprayed ink, a plurality of ink accommodation units 66 corresponding to the head chips 12 of FIG. 2 may be formed on the platen 60.

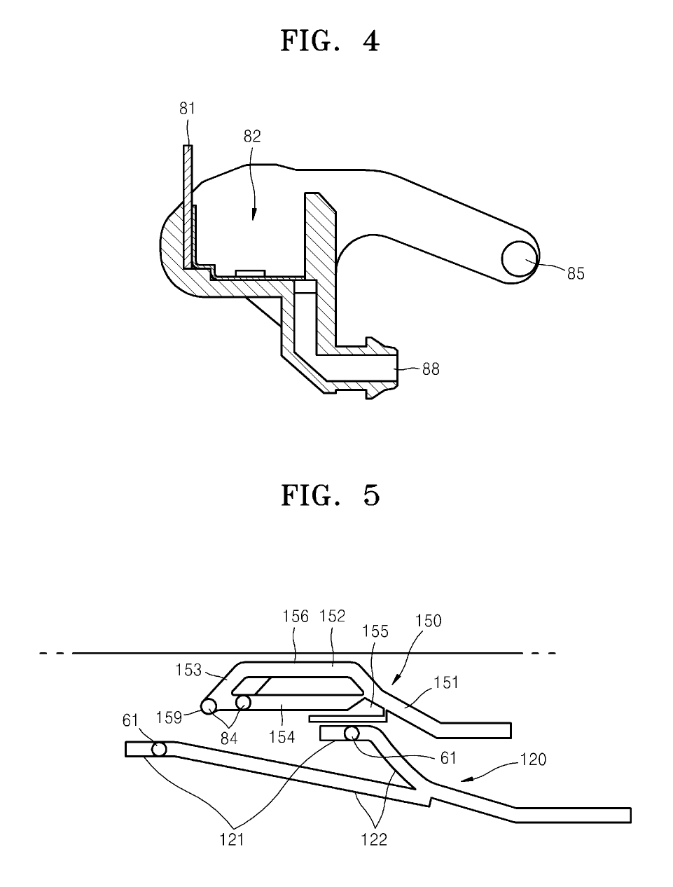

FIG. 4 is a cross-sectional view of the wiping unit 80 according to an exemplary embodiment of the present general inventive concept. Referring to FIGS. 3 and 4, the wiping unit 80 includes a wiper 81 to clean the nozzle unit 11. The wiper 81 may have a single or multiple blade shape having a length that can cover the entire length of the nozzle unit 11 along the main scanning direction M, or may have a roller shape. The wiping unit 80 includes a first protrusion 84 that is inserted into a wiping trace 150, which will be described later, and a second protrusion 85 that is connected to a connection unit 64 of the platen 60. The wiping unit 80 may further include an ink accommodation unit 82 that can accommodate sprayed/ejected ink. The ink accommodation unit 82 may contain ink and foreign materials removed from the nozzle unit 11. The length of the ink accommodation unit 82 may correspond to the entire length of the nozzle unit 11. The removed ink and foreign materials contained in the ink accommodation unit 82 may be discharged to a waste ink storage (not shown) through a drain 88.

FIG. 5 is a schematic drawing of a guide slot 120 and the wiping trace 150. Referring to FIGS. 1B and 5, the platen 60 may be moved to the printing position or the maintenance position by the guide slot 120 provided on sidewalls 101 and 102 of the inkjet image forming apparatus. The platen 60 includes protrusions 61 on sides thereof. The protrusions 61 are inserted into the guide slot 120. The guide slot 120 includes a parallel section 121 parallel to the paper conveying path 100 and a slope section 122 having a downward slope.

Referring to FIGS. 1A, 1B, and 3, the platen 60 is driven by a maintenance motor 301. A shaft 530 is rotatably supported on the sidewalls 101 and 102 of the inkjet image forming apparatus. Cutting parts 531 are provided on both ends of the shaft 530. A pair of first connection arms 541 is connected to the cutting parts 531 of the shaft 530, and is rotatably connected to a pair of second connection arms 542. A gear 401 is coupled to the cutting parts 531. The maintenance motor 301 moves the platen 60 to the printing position and the maintenance position by rotating the gear 401 forward and backward. A slot 543 having a long hole shape is formed in the second connection arm 542. A guide pole 62 on the platen 60 is inserted into the slot 543.

Referring to FIGS. 1B and 5, the wiping unit 80 according to the present embodiment moves together with the platen 60 while being guided by the wiping trace 150 provided on the sidewalls 101 and 102 of the inkjet image forming apparatus. The first protrusion 84 of the wiping unit 80 is coupled to the wiping trace 150. The wiping trace 150 includes a first section 151 in which the wiping unit 80 is guided to contact the nozzle unit 11 as the platen 60 moves from the maintenance position to the printing position and a second section 152 in which the wiping unit 80 is maintained in contact with the nozzle unit 11. Also, the wiping trace 150 further includes a third section 153 in which the wiping unit 80 is separated from the nozzle unit 11. The wiping trace 150 further includes a fourth section 154 in which the wiping unit 80 is guided while not contacting the nozzle unit 11 when the platen 60 moves from the printing position to the maintenance position. An edge unit 63 of the platen 60 pushes the wiping unit 80 while the platen 60 moves from the maintenance position to the printing position. When the first protrusion 84 reaches an end part of the second section 152, the first protrusion 84 enters the fourth section 154 passing through the third section 153 due to the weight of the wiping unit 80. A concave stopper 159 is provided at the beginning part of the fourth section 154, and the first protrusion 84 is inserted into the stopper 159. An elastic arm 155 allows the first protrusion 84 to enter the first section 151 from the fourth section 154, and performs as a latch that blocks the first protrusion 84 from moving to the fourth section 154 from the first section 151. When the platen 60 moves from the printing position to the maintenance position, the connection unit 64 of the platen 60 pulls the second protrusion 85, and thus the wiping unit 80 moves together with the platen 60 by being guided in the fourth section 154. According to the configuration described above, as shown in FIG. 1A, the wiping unit 80 is positioned in the first position, where the wiping unit 80 does not interrupt the paper conveying path 100, when the platen 60 is positioned in the printing position. While the platen 60 moves from the printing position to the maintenance position, the wiping unit 80 moves to the second position by being guided in and along the fourth section 154, and at this point, the wiper 81 does not contact the nozzle unit 11. While the platen 60 moves from the maintenance position to the printing position, the wiping unit 80 is guided by the first and second sections 151 and 152, and the wiper 81 cleans the nozzle unit 11. When the platen 60 is positioned in the maintenance position, the wiping unit 80 is positioned in the second position to operate first and second shutters 230 and 240 (FIG. 9), which will be described in more detail later. The wiping unit 80 may have a third position that is a slightly shifted position toward the first position from the second position. The third position is a position of the wiping unit 80 when the first and second shutters 230 and 240 completely block light emitting windows 206 and light receiving windows 213 after starting to rotate in a state where light emitting windows 206 and light receiving windows 213 are opened. At the third position, the wiping unit 80 is guided by the first section 151 of the wiping trace 150, but the wiper 81 does not contact the nozzle unit 11.

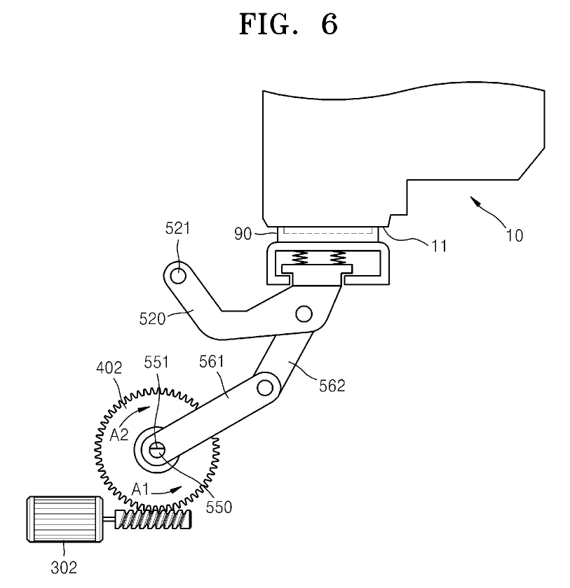

FIG. 6 is a side view of the cap member 90 positioned in a capping position. Referring to FIGS. 1A and 6, the cap member 90 can be installed on the cap arm 520. A shaft 550 is rotatably supported on the sidewalls 101 and 102 of the inkjet image forming apparatus. Cutting parts 551 are formed on both ends of the shaft 530. A pair of third connection arms 561 is coupled to the cutting parts 551 of the shaft 550, and is rotatably connected to a pair of fourth connection arms 562. The fourth connection arms 562 are rotatably connected to a cap arm 520. The cutting parts 551 of the shaft 550 are connected to a gear 402.

When the gear 402 rotates in a direction Al by a motor 302, the cap arm 520 rotates with respect to a hinge 521, and the cap member 90 moves from the capping position shown in FIG. 6 to an uncapping position as shown in FIG. 1A. When the gear 402 rotates in a direction A2, the cap member 90 moves from the uncapping position as shown in FIG. 1A to the capping position as shown in FIG. 6.

Malfunctioning nozzles refer to nozzles that do not eject ink properly due to being blocked by solidified ink or foreign materials, such as dust, etc. Since the array inkjet head 10 is in a fixed state when printing an image, if there is a malfunctioning nozzle, a white line can be produced in the image. Thus, it is necessary to determine whether the printing operation is performed properly by applying an appropriate compensate printing process according to the number or location of malfunctioning nozzles, or without performing the printing operation, to give the user a warning that the printing operation cannot be properly performed due to malfunctioning nozzles using an error message or a warning sound.

The inkjet image forming apparatus according to the current embodiment of the inventive concept can detect the number and positions of malfunctioning nozzles using an optical method.

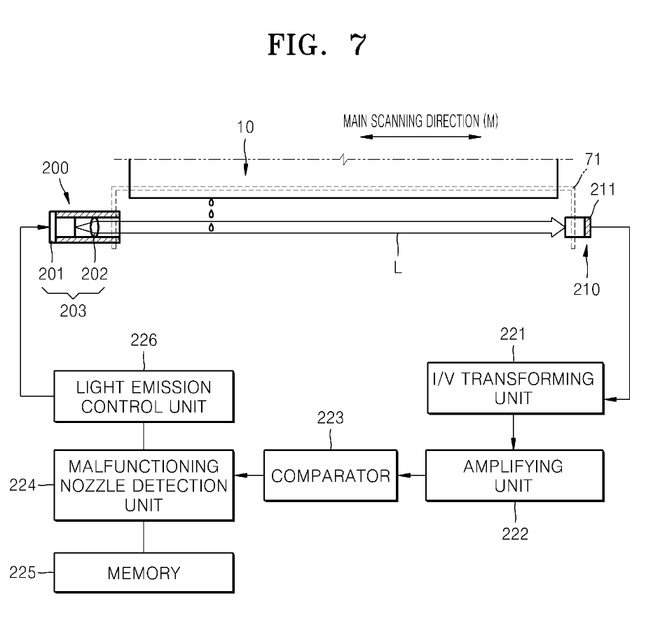

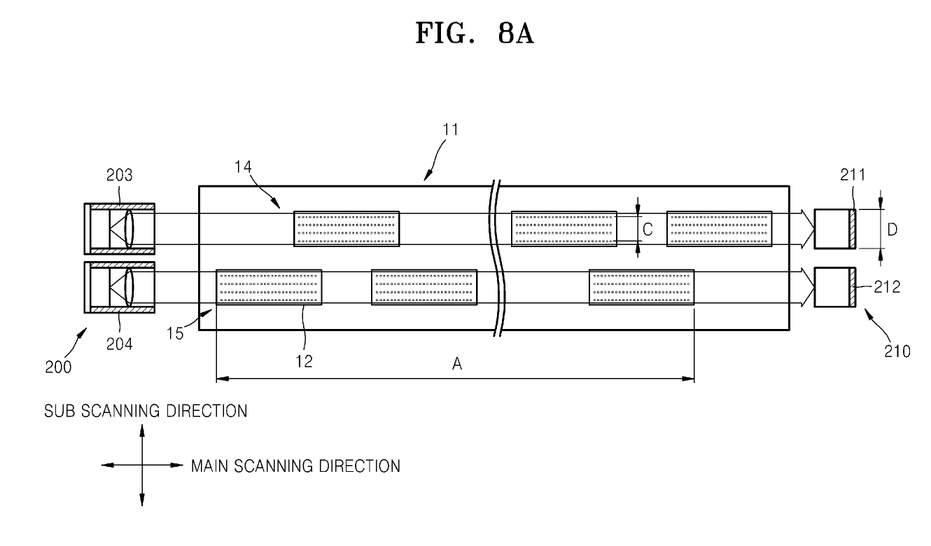

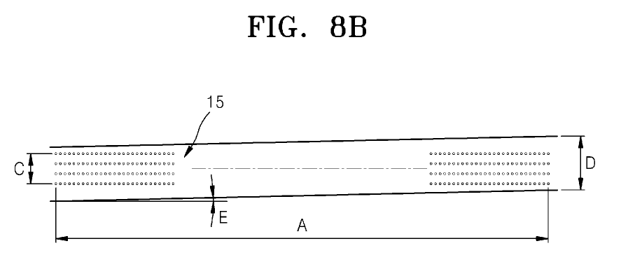

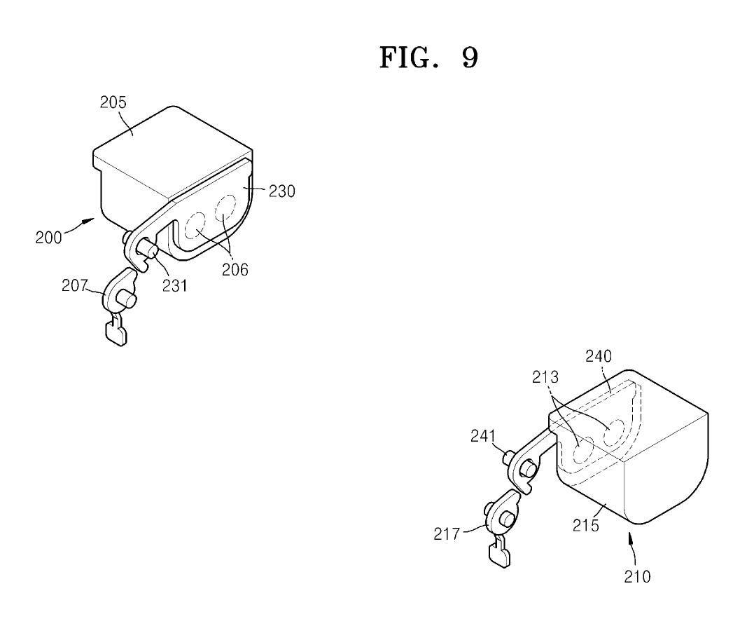

FIG. 7 is a block diagram showing a process of optically detecting malfunctioning nozzles employed in the inkjet image forming apparatus of FIG. 1A, according to an embodiment of the present general inventive concept. FIG. 8A is a plan view showing the dispositions of head chip rows, a light emitting unit 200, and a light receiving unit 210. Referring to FIGS. 7 and 8A, the light emitting unit 200 radiates light L and is provided on a side of the array inkjet head 10 along the main scanning direction M. The light receiving unit 210 faces the light emitting unit 200 to detect light L and is disposed on another side of the array inkjet head 10 and also along the main scanning direction M. The light emitting unit 200 includes at least one light emitting device 203. The light emitting device 203 includes a light source 201 that radiates light L and a lens 202 that transforms light L emitted from the light source 201 to cover a width of the head chips 12 along the sub-scanning direction S. More specifically, the lens 202 transforms light L emitted from the light source 201 to cover a distance C between the nozzles separated the furthest along the sub-scanning direction S in the head chips 12. The light source 201 may be, for example, a laser. The light receiving unit 210 includes a light receiving device 211.

In the nozzle unit 11, as shown in FIG. 8A, if the head chips 12 are divided into two head chip rows 14 and 15 separated from each other in the sub-scanning direction S, the light emitting unit 200 may include two light emitting devices 203 and 204 corresponding to the head chip rows 14 and 15, respectively. Also, the light receiving unit 210 may include two light receiving devices 211 and 212 corresponding to the two light emitting devices 203 and 204, respectively. The light emitting device 203 and the light receiving device 211 detect all nozzles of the head chip row 14, and the light emitting device 204 and the light receiving device 212 detect all nozzles of the head chip row 15. In the current embodiment, a case where the nozzle unit 11 includes the two head chip rows 14 and 15 has been explained. However, the scope of the present inventive concept is not limited thereto. When the number of head chip rows is more than two, the light emitting unit 200 and the light receiving unit 210 have the same number of light emitting devices and the same number of light receiving devices, respectively, corresponding to the number of head chip rows provided.

FIG. 8B is a plan view explaining an alignment error angle E of the light emitting unit 200 and the light receiving unit 210. Although the alignment of the light emitting device 204 and the light receiving device 212 are slightly miss-aligned, the light emitting device 204 and the light receiving device 212 must cover all the nozzles 13 of the head chip rows (14 or 15). Therefore, the alignment error angle E of the light emitting device 204 and the light receiving device 212 need be controlled.

In FIG. 8B, it is assumed that a length of the head chip row 15 in the main scanning direction M is A, a gap between the nozzles furthest from each other in one of the head chips 12 in the sub-scanning direction S is C, and a width of the light receiving device 211 is D, a permissible angle for the alignment error angle E of the light emitting device 204 and the light receiving device 212 is equal to or less than Arctan[(D−C)/A]. The light emitting unit 200 and the light receiving unit 210 can be coupled to the supporting member 71. In this way, the accuracy of detecting malfunctioning nozzles may therefore be increased by defining the alignment error angle E.

It is possible to make the alignment error angle E of the light emitting unit 200 and the light receiving unit 210 to be dependent on the manufacturing precision of the supporting member 71 by coupling the light emitting unit 200 and the light receiving unit 210 to the same supporting member 71. In other words, if the coupling relationship between the supporting member 71 and the frame 103 is determined, even if there is any alignment error, the alignment error angle E of the light emitting unit 200 and the light receiving unit 210 can be readily corrected to be within a permissible range by modifying only the supporting member 71.

FIG. 9 is a perspective view of the light emitting unit 200 and the light receiving unit 210 according to an embodiment of the present general inventive concept. Referring to FIG. 9, the light emitting unit 200 includes a first case 205 that accommodates the light emitting device 203 and a first shutter 230 to open and/or close the light emitting windows 206 from where light L is emitted. The first shutter 230 is rotatably installed on an axis 231. The axis 231 may be installed, for example, on the first case 205, the sidewall 101, or the supporting member 71. The light receiving unit 210 includes a second case 215 to accommodate the light receiving device 211 and a second shutter 240 to open and/or close the light receiving windows 213. The second shutter 240 may be rotatably installed on an axis 241. The axis 241 may be installed, for example, on the second case 215, the sidewall 102, or the supporting member 71. The first and second shutters 230 and 240 may be positioned by self-weight at positions that block the light emitting windows 206 and the light receiving windows 213, respectively. Although not shown, an elastic member that applies an elastic force to the first and second shutters 230 and 240 in a direction where the first and second shutters 230 and 240 can block the light emitting windows 206 and light receiving windows 213 may be provided. The first and second shutters 230 and 240 according to the current embodiment are operated by moving the wiping unit 80 to open the light emitting windows 206 and the light receiving windows 213. Rotation levers 207 and 217 are rotated due to the interference with the moving wiping unit 80, and operate the first and second shutters 230 and 240, respectively. The rotation levers 207 and 217 may be installed, for example, on the first and second cases 205 and 215, the sidewalls 101 and 102, or the supporting member 71.

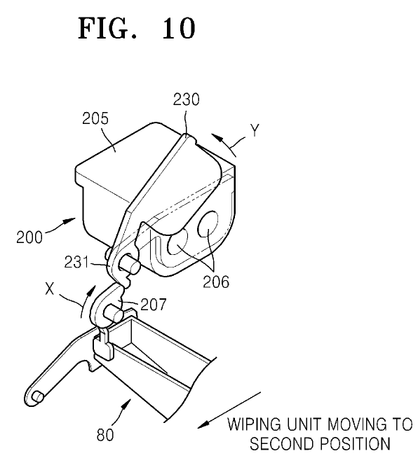

Ink fog may be generated during a printing operation when ink is ejected from a plurality of nozzles 13. Ink fog can occur as a result of the ejecting of the ink through the nozzles 13, or during spraying of the ink through the nozzles 13. The ink fog can contaminate the light emitting device 203 (204) and the light receiving device 211 (212) through the light emitting windows 206 and the light receiving windows 213. When the wiping unit 80 is positioned in the first position for printing, that is, the wiping unit 80 is positioned in the position as shown in FIG. 1, the first and second shutters 230 and 240 are positioned in positions to block the light emitting windows 206 and the light receiving windows 213. In order to detect malfunctioning nozzles, the platen 60 and the wiping unit 80 are positioned away from a lower side of the nozzle unit 11. For this purpose, the platen 60 is moved to the maintenance position by being guided by the guide slot 120 (refer to FIG. 5). The wiping unit 80 is moved to the second position to detect malfunctioning nozzles from the first position to print by being guided by the fourth section 154 of the wiping trace 150. At this point, as shown in FIG. 10, the wiping unit 80 contacts the rotation lever 207 (217). As the wiping unit 80 moves to the second position, the rotation lever 207 rotates in a direction X, and thus, the first shutter 230 rotates in a direction Y. Thus, the light emitting windows 206 are opened. When the platen 60 reaches the maintenance position and the wiping unit 80 reaches the second position, the first shutter 230 is maintained at the position where the light emitting windows 206 are opened. When the detection of malfunctioning nozzles is completed and the platen 60 moves to the printing position, the wiping unit 80 is moved while being guided by the first and second sections 151 and 152. At this point, the rotation lever 207 rotates in a direction opposite to the direction X, and the first shutter 230 rotates to a position where the light emitting windows 206 are blocked due to the self-weight thereof or elastic force of an elastic member. The wiping unit 80 is positioned in the first position for printing after the nozzle unit 11 is cleaned using the wiper 81. The operation of the second shutter 240 is identical to the operation of the first shutter 230 described above.

The wiping unit 80 may be positioned in the third position when the printing operation is not performed. In this case, since the light emitting windows 206 and the light receiving windows 213 are blocked by the first and second shutters 230 and 240, the light emitting unit 200 and the light receiving unit 210 can be prevented from being contaminated by dust or other foreign materials.

A method of detecting malfunctioning nozzles in the inkjet image forming apparatus having the above configuration will now be described.

In order to detect malfunctioning nozzles, when the nozzle unit 11 is capped by the cap member 90, the cap member 90 is moved to the uncapping position as shown in FIG. 1 by driving the motor 302. In this case, the platen 60 and the wiping unit 80 are positioned in the maintenance position and the second position respectively. Also, the wiping unit 80 may be positioned in the third position.

In order to increase the reliability of detecting malfunctioning nozzles, a wiping operation to clean the nozzle unit 11 may be performed prior to detecting malfunctioning nozzles. For this purpose, the platen 60 and the wiping unit 80 are moved to the printing position and the first position, respectively, by driving the motor 301. In this process, the wiping unit 80 is guided by the first and second sections 151 and 152 of the wiping trace 150 and the wiper 81 contacts the nozzle unit 11. While the wiping unit 80 is moved while guided by the second section 152, the wiper 81 removes foreign materials from the nozzle unit 11. At this point, ink spitting may be performed. When the ink accommodation unit 82 provided on the wiping unit 80 is positioned below the nozzle unit 11 while performing wiping, all the nozzles 13 spit (eject) a few dots of ink to remove different color ink that can flow into the nozzles 13 in the course of the wiping process and form a meniscus in the nozzles 13. At this point, since the wiping unit 80 has passed the third position, the light emitting windows 206 and the light receiving windows 213 are blocked by the first and second shutters 230 and 240. Therefore, the light emitting device 203 and the light receiving device 211 can be prevented from being contaminated due to ink fog generated during the spitting process.

When the wiping unit 80 reaches the first position, the platen 60 and the wiping unit 80 are moved to the maintenance position and the second position by driving the motor 301, respectively. The wiping unit 80 is guided by the fourth section 154 of the wiping trace 150. The wiping unit 80 rotates the rotation levers 207 and 217 while the wiping unit 80 moves to the second position. Then, the first and second shutters 230 and 240 rotate to a position to open the light emitting windows 206 and the light receiving windows 213, respectively. When the wiping unit 80 reaches the second position, the light emitting windows 206 and the light receiving windows 213 are completely opened. In this state, the detection of malfunctioning nozzles begins.

A malfunctioning nozzle detection unit 224 controls the light emitting unit 200 to radiate light L through a light emission control unit 226. The malfunctioning nozzle detection unit 224 sequentially drives the plurality of nozzles 13 of the array head 10 to consecutively eject a few dots of ink, for example, 5 dots. Ejected ink falls into a waste ink accommodation unit 4, crossing the light L. When ink is normally ejected, ejected ink droplets block a portion of the light L, and thus, an amount of the light L detected by the light receiving device 211 is reduced. If ink is not ejected or a smaller amount of ink than normal is ejected from the nozzles 13, the amount of the light L detected by the light receiving device 211 is greater than the amount detected during a normal ejection. The light receiving device 211 generates a current signal corresponding to the detected amount of the light L. The current signal is transformed to a voltage signal by an I/V transforming unit 221, and is input to a comparator 223 after being amplified by an amplifying unit 222. The comparator 223 generates a final signal by comparing the level of the amplified voltage signal to a predetermined threshold level. The comparator 223 outputs the final signal as, for example, when ink is normally ejected, a high signal, and when ink is abnormally ejected, a low signal. The malfunctioning nozzle detection unit 224 determines whether a nozzle is a malfunctioning nozzle by the final signal generated from the comparator 223. Addresses are allocated to each of the nozzles 13 of the array head 10, and the nozzles 13 are sequentially driven to eject ink. Afterwards, the number and position of malfunctioning nozzles can be determined by analyzing the detection signal of the light receiving unit 210. The malfunctioning nozzle detection unit 224 can store information regarding the malfunctioning nozzles and their position in a memory 225.

If a printing operation is not performed immediately after the detection of malfunctioning nozzles is completed, the wiping unit 80 may be moved to the third position. Then, since the light emitting windows 206 and the light receiving windows 213 are covered by the first and second shutters 230 and 240, the light emitting device 203 and the light receiving device 211 may be prevented from being contaminated by foreign materials, such as dust, when the printing operation is not performed. When the printing operation is performed, the platen 60 and the wiping unit 80 move to the printing position and the first position, respectively, and also the first and second shutters 230 and 240 cover the light emitting windows 206 and the light receiving windows 213, respectively. Thus, the light emitting device 203 and the light receiving device 211 can be prevented from being contaminated by ink fog generated during the printing operation. If there are any malfunctioning nozzles, compensation printing can be performed. For example, if nozzles that eject black ink are not functioning properly, a composite black printing can be performed at a location where the black ink must be ejected by the malfunctioning nozzles using nozzles that eject color ink that are located corresponding to the location of the malfunctioning nozzles. Also, a printing failure due to the malfunctioning nozzles can be compensated for by a certain degree by ejecting the same color ink on adjacent locations to the location where the ink must be ejected by the malfunctioning nozzles using nozzles that eject the same color ink located adjacent to the malfunctioning nozzles.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus comprising:
an array inkjet head including at least one head chip row, the at least one head chip having a plurality of head chips on which nozzles are formed;
a light emitting unit including a light emitting device that is disposed on a first side of the head chip rows in a main scanning direction and radiates light;
a light receiving unit including a light receiving device that is disposed on a second side of the head chip rows in the main scanning direction and faces the light emitting device to detect the light; and
a malfunctioning nozzle detection unit that controls the array inkjet head to eject ink across the light and detects malfunctioning nozzles using detection signals received from the light receiving unit, wherein
an alignment error angle between the light emitting unit and the light receiving unit is Arctan[(D−C)/A] or less when a length of the head chip rows in the main scanning direction is A, a gap between nozzles furthest from each other in a sub-scanning direction in one of the head chips is C, and a width of the light receiving unit is D.

2. The inkjet image forming apparatus of claim 1, further comprising:
a frame that forms a structure of the inkjet image forming apparatus; and
a supporting member that is coupled to the frame, and to which the light emitting unit and the light receiving unit are coupled.
The inkjet image forming apparatus of claim 1, wherein
the array inkjet head comprises a plurality of the head chip rows,
the light emitting unit comprises a plurality of the light emitting devices corresponding to the plurality of the head chip rows, and
the light receiving unit comprises a plurality of the light receiving devices corresponding to the plurality of the light emitting devices.

4. An inkjet image forming apparatus comprising:
an array inkjet head including at least one head chip row, the at least one head chip row having a plurality of head chips on which nozzles are formed;
a light emitting unit including a light emitting device that is disposed on a first side of the head chip rows in a main scanning direction and radiates light;
a light receiving unit including a light receiving device that is disposed on a second side of the head chip rows in the main scanning direction and faces the light emitting device to detect the emitted light; and
a malfunctioning nozzle detection unit that controls the array inkjet head to eject ink across the emitted light and detects malfunctioning nozzles using detection signals received from the light receiving unit, wherein
the light emitting unit and the light receiving unit are coupled to a supporting member, and the supporting member is coupled to a frame on which the array inkjet head is mounted.

5. The inkjet image forming apparatus of claim 4, wherein
the array inkjet head comprises a plurality of the head chip rows,
the light emitting unit comprises a plurality of the light emitting devices corresponding to the plurality of the head chip rows, and
the light receiving unit comprises a plurality of light receiving devices corresponding to the plurality of the light emitting devices.

6. The inkjet image forming apparatus of claim 4, wherein:
the light emitting unit further includes a first case enclosing the light emitting unit, the first case having at least one window in which the emitted light can exit; and
the light receiving unit further includes a second case enclosing the light receiving unit, the second case having at least one window in which the emitted light is received.

7. The inkjet image forming apparatus of claim 6, wherein
the first case further includes a first shutter movable between blocking and unblocking positions of the at least one window; and
the second case further includes a second shutter movable between blocking and unblocking positions of the at least one window.

8. The inkjet image forming apparatus of claim 7, wherein the first shutter and the second shutter are moved to the blocking position of the respective at least one window when the malfunctioning nozzle detection unit controls the array inkjet head to eject ink across the emitted light such that the respective at least one window is blocked from the ejected ink.
